(19) United States
(12) Patent Application Publication
(10) Pub. No.: US 2002/0122881 A1
(43) Pub. Date: Sep. 5, 2002

(54) Micromechanical device recoat methods

(76) Inventors: Toshiyuki Kaeriyama, Tsukuba-gun (JP); Richard L. Knipe, McKinney, TX (US); Michael A. Mignardi, Richardson, TX (US); Simon Joshua Jacobs, Lucas, TX (US)

Correspondence Address: Charles A. Brill, Texas Instruments Incorporated, MS 3999, P.O. Box 655474, Dallas, TX, 75265, US

(21) Appl. No.: 10/038,791

(22) Filed: Dec. 31, 2001

Related U.S. Application Data
(60) Provisional application No. 60/258,997, filed on Dec. 29, 2000.

(51) Int. Cl. B05D 3/12; B05D 1/02; B05D 3/06; B05D 1/18

(52) U.S. Cl. 427/58; 427/430.1; 427/558; 427/240; 427/421

(57) ABSTRACT

A method of fabricating a micromechanical device. Several of the micromechanical devices are fabricated 20 on a common wafer. After the devices are fabricated, the sacrificial layers are removed 22 leaving open spaces where the sacrificial layers once were. These open spaces allow for movement of the components of the micromechanical device. The devices optionally are passivated 24, which may include the application of a lubricant. After the devices have been passivated, they are tested 26 in wafer form. After testing 26, any surface treatments that are not compatible with the remainder of the processing steps are removed 28. The substrate wafer containing the completed devices receives a conformal overcoat 30. The overcoat layer is thick enough to project the micromechanical structures, but thin and light enough to prevent deforming the underlying micromechanical structures. Once the devices on the wafer are overcoated, the wafer is separated 32, and the known good devices are cleaned 34 to remove debris left by the dicing process. Once the devices are separated and cleaned, the overcoat may be removed, however, the overcoat typically is left in place to protect the device during the initial stages of the packaging process. Typically the devices are mounted 36 in the package substrate, the overcoat removed 38 from the devices, and the package containing the micromechanical device finished by sealing the package to enclose the device.

### CROSS-REFERENCE TO RELATED APPLICATIONS

The following patents and/or commonly assigned patent applications are hereby incorporated herein by reference:

| Patent No. | Filing Date | Issue Date | Title |
|---|---|---|---|
| 5,061,049 | Sept. 13, 1990 | Oct. 29, 1991 | Spatial Light Modulator |
| | | | and Method |
| 5,583,688 | Dec. 21, 1993 | Dec. 10, 1996 | Multi-Level Digital |
| | | | Micromirror Device |
| 60/213,043 | June 21, 2000 | | Re-coating MEMS |
| | | | devices Using Dissolved |
| | | | Resins |
| TI-28885 | Herewith | | Micromechanical Device |
| | | | Recoat Methods |

### FIELD OF THE INVENTION

This invention relates to the field of micromechanical systems, more particularly to methods of manufacturing micromechanical devices.

### BACKGROUND OF THE INVENTION

Micromechanical devices are small structures typically fabricated on a semiconductor wafer using techniques such as optical lithography, doping, metal sputtering, oxide deposition, and plasma etching which have been developed for the fabrication of integrated circuits.

Micromirror devices are one type of micromechanical device. Other types of micromechanical devices include accelerometers, pressure and flow sensors, gears and motors. While some micromechanical devices, such as pressure sensors, flow sensors, and micromirrors have found commercial success, other types have not yet been commercially viable.

Micromirror devices are primarily used in optical display systems. In display systems, the micromirror is a light modulator that uses digital image data to modulate a beam of light by selectively reflecting portions of the beam of light to a display screen. While analog modes of operation are possible, micromirrors typically operate in a digital bistable mode of operation and as such are the core of the first true digital full-color image projection systems.

Micromirrors have evolved rapidly over the past ten to fifteen years. Early devices used a deformable reflective membrane which, when electrostatically attracted to an underlying address electrode, dimpled toward the address electrode. Schlieren optics illuminate the membrane and create an image from the light scattered by the dimpled portions of the membrane. Schlieren systems enabled the membrane devices to form images, but the images formed were very dim and had low contrast ratios, making them unsuitable for most image display applications.

Later micromirror devices used flaps or diving board-shaped cantilever beams of silicon or aluminum, coupled with dark-field optics to create images having improved contrast ratios. Flap and cantilever beam devices typically used a single metal layer to form the top reflective layer of the device. This single metal layer tended to deform over a large region, however, which scattered light impinging on the deformed portion. Torsion beam devices use a thin metal layer to form a torsion beam, which is referred to as a hinge, and a thicker metal layer to form a rigid member, or beam, typically having a mirror-like surface: concentrating the deformation on a relatively small portion of the micromirror surface. The rigid mirror remains flat while the hinges deform, minimizing the amount of light scattered by the device and improving the contrast ratio of the device.

Recent micromirror configurations, called hidden-hinge designs, further improve the image contrast ratio by fabricating the mirror on a pedestal above the torsion beams. The elevated mirror covers the torsion beams, torsion beam supports, and a rigid yoke connecting the torsion beams and mirror support, further improving the contrast ratio of images produced by the device.

Other micromechanical devices include accelerometers, pressure and other sensors, and motors. These devices all share the common feature of having very fragile structures. The fragile structures can make it difficult to manufacture the micromechanical devices, especially in a cost effective manner. For example, once the sacrificial layers beneath the micromirror have been removed, the mirrors are very fragile and very susceptible to damage due to particles.

Because the particles become trapped in the mechanical structure of the micromirror array, and because the particles cannot be washed out of the array, it is necessary to separate the wafers on which the devices are formed, and wash the debris off the devices, prior to removing the sacrificial layers under the mirrors—also called undercutting the mirrors. Furthermore, because the chip bond-out process also creates particles, it is desirable to mount the device in a package substrate and perform the chip bond-out process prior to undercutting the mirrors.

Unfortunately, it is only after the mirrors have been undercut that the micromirror array is able to be tested. Assuming the production flow described above, all of the devices manufactured must be mounted on package substrates, bonded-out to the substrates, and undercut prior to testing the devices. Additionally, micromirrors typically require some sort of lubrication to prevent the micromirror from sticking to the landing surfaces when it is deflected. Therefore, the devices must also be lubricated and the package lid or window applied prior to testing the devices. Because a typical micromirror package is very expensive, the packaging costs associated with devices that do not function greatly increase the cost of production and must be recovered by the devices that do function.

What is needed is a method of testing the micromechanical structure of a micromirror array prior to packaging the micromirror array. This method would enable a production flow that would only package the known good devices. Thus, the significant cost associated with the packaging the failed die would be eliminated.

### SUMMARY OF THE INVENTION

Objects and advantages will be obvious, and will in part appear hereinafter and will be accomplished by the present invention which provides a method for coating micromechanical devices. One embodiment of the claimed invention provides a method of fabricating a micromechanical device. The method comprises forming a micromechanical devices, overcoating the micromechanical devices, and later removing the overcoat from the micromechanical devices.

Another embodiment of the present invention provides a method comprising: forming at least two micromechanical devices on a common substrate; applying a liquid overcoat material to the micromechanical devices; separating the common substrate to separate the devices; and removing the overcoat from the micromechanical devices.

Another embodiment of the present invention provides a method comprising: forming at least two micromechanical devices on a common substrate; immersing the common substrate in a liquid overcoat material to coat the micromechanical devices; separating the common substrate to separate the devices; and removing the overcoat from the micromechanical devices.

Another embodiment of the present invention provides a method comprising: forming at least two micromechanical devices on a common substrate; spraying a liquid overcoat material onto the common substrate to coat the micromechanical devices; separating the common substrate to separate the devices; and removing the overcoat from the micromechanical devices.

Another embodiment of the present invention provides a method comprising: forming at least two micromechanical devices on a common substrate; nebulizing a liquid overcoat material; spraying the nebulized liquid overcoat material onto the common substrate to coat the micromechanical devices; separating the common substrate to separate the devices; and removing the overcoat from the micromechanical devices.

Another embodiment of the present invention provides a method comprising: forming at least two micromechanical devices on a common substrate; dispensing droplets of a liquid overcoat material from a nozzle using a heated droplet dispenser; depositing the droplets onto the common substrate to coat the micromechanical devices; separating the common substrate to separate the devices; and removing the overcoat from the micromechanical devices.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram of a method of fabricating a micromechanical device according to the present invention.

FIG. 2 is a perspective view of a small portion of a micromirror array of the prior art.

FIG. 3 is an exploded perspective view of a single micromirror element from the micromirror array of FIG. 3.

FIG. 4 is a side view of a portion of the array of FIG. 3.

FIG. 5 is a side view of the array of FIG. 4 showing a liquid protective overcoat material deposited according to the methods described herein.

FIG. 6 is a side view of the array of FIG. 5 showing the protective overcoat solidified according to the methods described herein.

### DETAILED DESCRIPTION OF THE PREFERRED EMBODIMENTS

A method has been developed to allow a fully fabricated micromechanical device to be coated with a protective overcoat. This method enables a wafer of micromechanical devices, such as a micromirror device, to be fully fabricated, lubricated, and tested prior to separating the wafer into individual devices. This method protects the devices by applying a protective overcoat to the devices, and removing the overcoat after the wafer has been separated and the debris washed from the surface of the wafer.

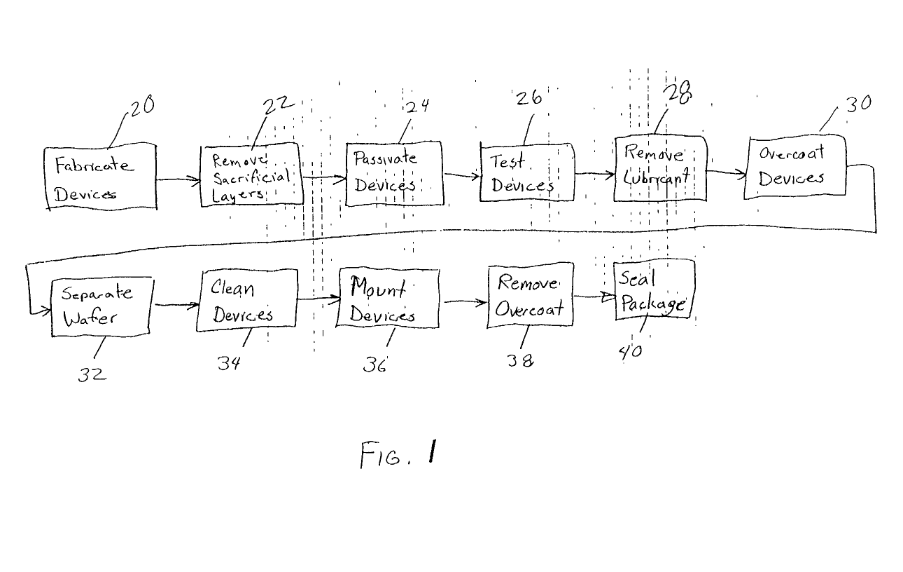

FIG. 1 is a block diagram of a method of fabricating a micromechanical device according to the present invention. Several of the micromechanical devices, which typically are microelectromechanical systems or MEMS, are fabricated 20 on a common wafer. Typical micromechanical devices are fabricated on one or more sacrificial layers. The sacrificial layers typically are photoresist. The sacrificial layers provide support for the various components of the micromechanical device during the fabrication process.

After the devices are fabricated, the sacrificial layers are removed 22 leaving open spaces where the sacrificial layers once were. These open spaces allow for movement of the components of the micromechanical device. For example, an accelerometer proof mass may defect into the open space, a motor may turn in the open space, or member may be deflected into the open space using electrostatic or electromagnetic force.

Moving devices typically require some sort of passivation of the surfaces of the device that will contact. The optional passivation 24 reduces the surface energy of the device, lowering the stiction encountered when various surfaces of the device come into contact. Part of the passivation process may include the addition of a lubricant to the device. For example, micromirror devices typically include a lubricant such as perfluorodecanoic acid, or PFDA. The PFDA is applied by activating the surface of the device and exposing the surface of the device to a PFDA vapor. The PFDA in the vapor condenses out of the vapor onto all of the surfaces of the device, forming a monolayer with a very low surface energy.

After the devices have been passivated, if necessary, they are tested 26 in wafer form. This test is the first opportunity to perform a fully functional test of the microstructure. The results of this functional test are recorded for later reference. After the wafer is separated, the devices that are known to be functional will be packaged, while the devices that are known not to function will be scrapped.

Once the testing 26 is complete, any surface treatments, such as a lubricant, that are not compatible with the remainder of the processing steps are removed 28. For example, PFDA lubricant is not compatible with the additional processing steps and is removed. The lubricant may be removed by an ash step. Compatible lubricants and surface treatments may be left in place.

The substrate wafer containing the completed devices receives an overcoat 30. The overcoat is applied in liquid form to the wafer. The overcoat layer passes through the gaps between micromechanical structures and fills in the volume formerly occupied by the sacrificial layers. The method of applying the overcoat is described in detail below.

Once the devices on the wafer are overcoated, the wafer is separated 32. Typical wafer separation processes include sawing through the wafer, scribing and deforming the wafer to break the wafer along the scribe lines, and a partial saw break process in which the wafer is sawn part of the way through and then broken by deforming the wafer against a dome or roller. Any wafer separation process used in semiconductor wafer manufacturing likely may be used to separate the overcoated wafer.

Once the wafer or common substrate has been separated, or diced, the individual devices that tested good are collected and the known failed devices are scrapped. The known good devices are cleaned 34 to remove debris left by the dicing process. The cleaning process typically uses a water stream to rinse the debris from the surface of the wafer. Alternatively, the dicing debris may be blown from the surface of the devices by an air stream. Thus, the overcoat prevents damage to the micromechanical structures of the device to allow the use of a thorough cleaning process.

Once the devices are separated and cleaned, the overcoat may be removed. Since the devices will be packaged, however, the overcoat typically is left in place to protect the device during the initial stages of the packaging process. In the case of micromirror devices, the devices are mounted 36 in the package substrate.

The overcoat is removed 38 from the devices. The overcoat is removed by a process appropriate for the overcoat material and the nature of the device being coated. For example, an isotropic etch, or a dry plasma etch or ash process may be used. A dry process typically exerts less force on the micromechanical device and is therefore less likely to damage the frail structures of the device compared to a wet etch process. A wet chemical process, however, is more likely to thoroughly clean the device. One of the benefits of an overcoat process that fills in the voids underneath large structures such as micromirrors is that the overcoat supports the structure from beneath during the washing process—preventing the water stream from collapsing the micromirrors.

The overcoat typically is removed by a chemical dry etch process in which the overcoat layer is exposed to a CF₄ based plasma gas excited by microwave energy. Since the overcoat resin is comprised of carbon, hydrogen, and oxygen atoms, the resin's chemical bonds are easily cut by the F radicals provided by the chemical dry etching process.

Once the overcoat is completely removed, the package containing the micromechanical device is finished. Electrical connections, or bond wires, typically are connected between the device and electrical connections within the package substrate. The package is then sealed to enclose the device. For example, micromirror packages have a window attached to the package substrate.

Several methods of applying the overcoat material are proposed. Provided a suitable recoat material is available, the wafer and micromechanical devices may be immersed in the recoat material. To prevent damage to the devices, the recoat material must have a very low surface tension. A surface tension in the range of 20 to 30 dyn/cm is desired, although lower surface tension materials are also acceptable. If the surface tension is too high, the capillary forces will pull on the micromechanical structures and destroy the device as the device is being wetted. The recoat material should wet the structures being coated.

A suitable recoat material will also have a low viscosity. Too high of viscosity will prevent the recoat material from flowing through gaps in the material, for example between gaps in the mirrors of a micromirror device. Ultrasonic stimulation and rotation of the wafer are sometimes used to increase the ability of a recoat material to flow through the mirror gaps. The viscosity of the recoat material typically is in the range of 3 to 10 cps (at 25° C.).

Another important characteristic of the recoat material is the amount of shrinkage experienced as the recoat material cures. Too high of a shrinkage level will result in the material collapsing the micromechanical structure as the resin cures and shrinks. A suitable recoat material has 5 to 10% shrinkage or less by volume.

An ideal recoat material has a viscosity of less than 1 cps at 250° C. and 0% shrinkage. Materials that do not meet this ideal, however, are useful, especially with micromechanical devices that are structurally strong. Examples of suitable materials include urethane acrylate resins, epoxy acrylate resins, and acrylate monomers.

Instead of immersing the wafer of micromechanical devices in the recoat liquid, the recoat liquid may be dispensed onto the wafer and allowed to settle into the micromechanical structures. Slowly rotating the wafer assists in the even distribution and timely passage of the recoat material through the narrow mirror gaps in a micromirror array. Ultrasonic energy may also be applied to the mirror to help distribute the recoat material.

Alternate methods of applying the recoat liquid include spraying the liquid onto the wafer. High and low pressure sprays may be used, so long as the mechanical structures of the wafer are not harmed. For example, a pneumatic spray may be used to saturate the surface of the wafer, filling in the voids between and beneath the micromechanical structures formed on the wafer.

Nebulization techniques may also be used to create a spray of the recoat material. For example, Meinhard or ultrasonic nebulizers may be used to create a mist of the recoat material directed onto the wafer. Alternatively, a small quantity of the overcoat material may be rapidly heated and forced through a nozzle to create a droplet of the recoat material directed to the substrate wafer. A common device of this type is called an inkjet and is used to create ink droplets in the printing industry.

Once the recoat material has been deposited and distributed on the wafer containing the micromechanical devices, the recoat material is cured. Depending on the resin used to overcoat the wafer, ultraviolet light is used to polymerize the recoat material. A thermal cure may also be used to cure the resin, especially under structures like micromirrors that can block the ultraviolet radiation.

A solvent, such as methylethylketone (MEK), or isopropyl alcohol (IPA) may be used to rinse out unexposed resin. After rinsing, the wafer and overcoat are dried, typically during a bake process.

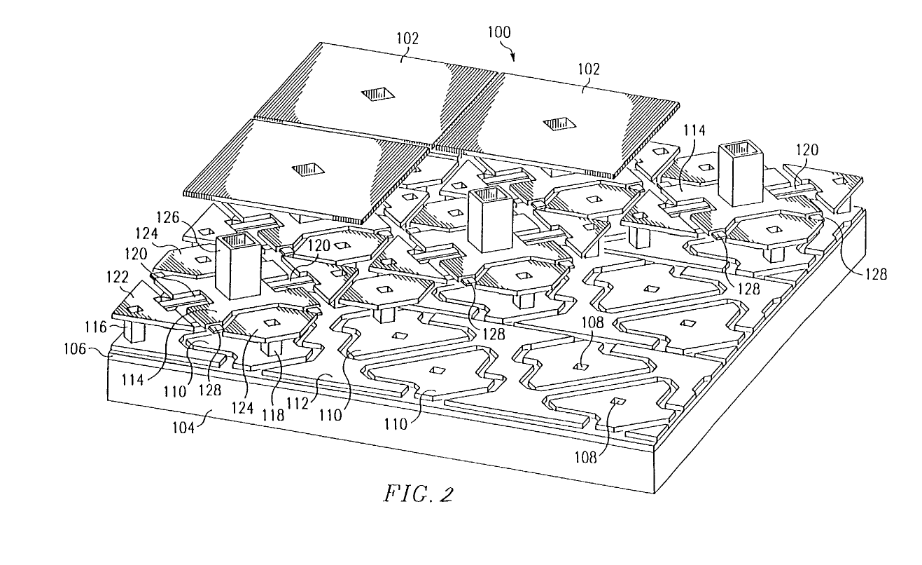

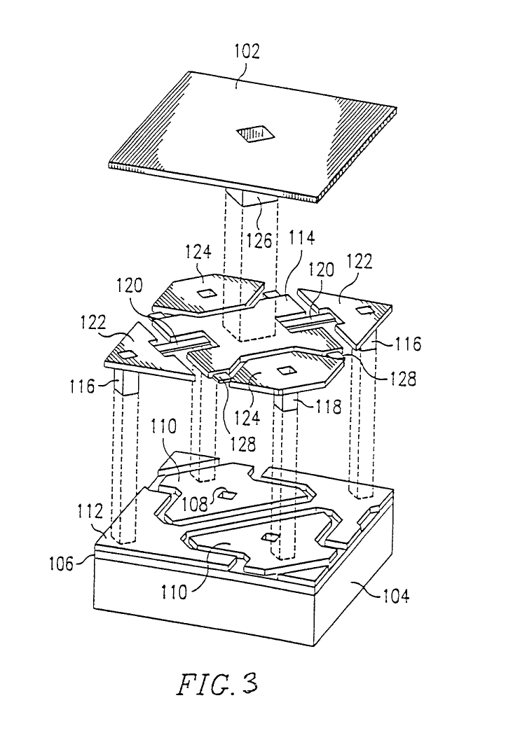

For purposes of example and not for purposes of limitation, one micromechanical structure that is especially difficult to manufacture without the overcoat process is a micromirror device. A typical hidden-hinge micromirror 100 is actually an orthogonal array of micromirror cells, or elements. This array often includes more than a thousand rows and columns of micromirrors. FIG. 2 shows a small portion of a micromirror array of the prior art with several mirrors 102 removed to show the underlying mechanical structure of the micromirror array. FIG. 3 is an exploded view of a single micromirror element of the prior art further detailing the relationships between the micromirror structures.

A micromirror is fabricated on a semiconductor, typically silicon, substrate 104. Electrical control circuitry is typically fabricated in or on the surface of the semiconductor substrate 104 using standard integrated circuit process flows. This circuitry typically includes, but is not limited to, a memory cell associated with, and typically underlying, each mirror 102 and digital logic circuits to control the transfer of the digital image data to the underlying memory cells. Voltage driver circuits to drive bias and reset signals to the mirror superstructure may also be fabricated on the micromirror substrate, or may be external to the micromirror. Image processing and formatting logic is also formed in the substrate 104 of some designs. For the purposes of this disclosure, addressing circuitry is considered to include any circuitry, including direct voltage connections and shared memory cells, used to control the direction of rotation of a micromirror.

The silicon substrate 104 and any necessary metal interconnection layers are isolated from the micromirror superstructure by an insulating layer 106 which is typically a deposited silicon dioxide layer on which the micromirror superstructure is formed. Holes, or vias, are opened in the oxide layer to allow electrical connection of the micromirror superstructure with the electronic circuitry formed in the substrate 104.

The first layer of the superstructure is a metalization layer, typically the third metalization layer and therefore often called M3. The first two metalization layers are typically required to interconnect the circuitry fabricated on the substrate. The third metalization layer is deposited on the insulating layer and patterned to form address electrodes 110 and a mirror bias connection 112. Some micromirror designs have landing electrodes which are separate and distinct structures but are electrically connected to the mirror bias connection 112. Landing electrodes limit the rotation of the mirror 102 and prevent the rotated mirror 102 or hinge yoke 114 from touching the address electrodes 110, which have a voltage potential relative to the mirror 102. If the mirror 102 contacts the address electrodes 110, the resulting short circuit could fuse the torsion hinges 116 or weld the mirror 102 to the address electrodes 110, in either case ruining the micromirror.

Since the same voltage is always applied both to the landing electrodes and the mirrors 102, the mirror bias connection and the landing electrodes are preferably combined in a single structure when possible. The landing electrodes are combined with the mirror bias connection 112 by including regions on the mirror bias/reset connection 112, called landing sites, which mechanically limit the rotation of the mirror 102 by contacting either the mirror 102 or the torsion hinge yoke 114. These landing sites are often coated with a material chosen to reduce the tendency of the mirror 102 and torsion hinge yoke 114 to stick to the landing site.

Mirror bias/reset voltages travel to each mirror 102 through a combination of paths using both the mirror bias/reset metalization 112 and the mirrors and torsion beams of adjacent mirror elements. Split reset designs require the array of mirrors to be subdivided into multiple subarrays each having an independent mirror bias connection. The landing electrode/mirror bias 112 configuration shown in FIG. 2 is ideally suited to split reset applications since the micromirror elements are easily segregated into electrically isolated rows or columns simply by isolating the mirror bias/reset layer between the subarrays. The mirror bias/reset layer of FIG. 2 is shown divided into rows of isolated elements.

A first layer of supports, typically called spacervias, is fabricated on the metal layer forming the address electrodes 110 and mirror bias connections 112. These spacervias, which include both hinge support spacervias 116 and upper address electrode spacervias 118, are typically formed by spinning a thin spacer layer over the address electrodes 110 and mirror bias connections 112. This thin spacer layer is typically a 1 μm thick layer of positive photoresist. After the photoresist layer is deposited, it is exposed, patterned, and deep UV hardened to form holes in which the spacervias will be formed. This spacer layer and a thicker spacer layer used later in the fabrication process are often called sacrificial layers since they are used only as forms during the fabrication process and are removed from the device prior to device operation.

A thin layer of metal is sputtered onto the spacer layer and into the holes. An oxide is then deposited over the thin metal layer and patterned to form an etch mask over the regions that later will form hinges 120. A thicker layer of metal, typically an aluminum alloy, is sputtered over the thin layer and oxide etch masks. Another layer of oxide is deposited and patterned to define the hinge yoke 114, hinge cap 122, and the upper address electrodes 124. After this second oxide layer is patterned, the two metals layers are etched simultaneously and the oxide etch stops removed to leave thick rigid hinge yokes 114, hinge caps 122, and upper address electrodes 124, and thin flexible torsion beams 120.

A thick spacer layer is then deposited over the thick metal layer and patterned to define holes in which mirror support spacervias 126 will be formed. The thick spacer layer is typically a 2 μm thick layer of positive photoresist. A layer of mirror metal, typically an aluminum alloy, is sputtered on the surface of the thick spacer layer and into the holes in the thick spacer layer. This metal layer is then patterned to form the mirrors 102 and both spacer layers are removed using a plasma etch.

Once the two spacer layers have been removed, the mirror is free to rotate about the axis formed by the torsion hinge. Electrostatic attraction between an address electrode 110 and a deflectable rigid member, which in effect form the two plates of an air gap capacitor, is used to rotate the mirror structure. Depending on the design of the micromirror device, the deflectable rigid member is the torsion beam yoke 114, the beam or mirror 102, a beam attached directly to the torsion hinges, or a combination thereof. The upper address electrodes 124 also electrostatically attract the deflectable rigid member.

The force created by the voltage potential is a function of the reciprocal of the distance between the two plates. As the rigid member rotates due to the electrostatic torque, the torsion beam hinges resist deformation with a restoring torque which is an approximately linear function of the angular deflection of the torsion beams. The structure rotates until the restoring torsion beam torque equals the electrostatic torque or until the rotation is mechanically blocked by contact between the rotating structure and a fixed component. As discussed below, most micromirror devices are operated in a digital mode wherein sufficiently large bias voltages are used to ensure full deflection of the micromirror superstructure.

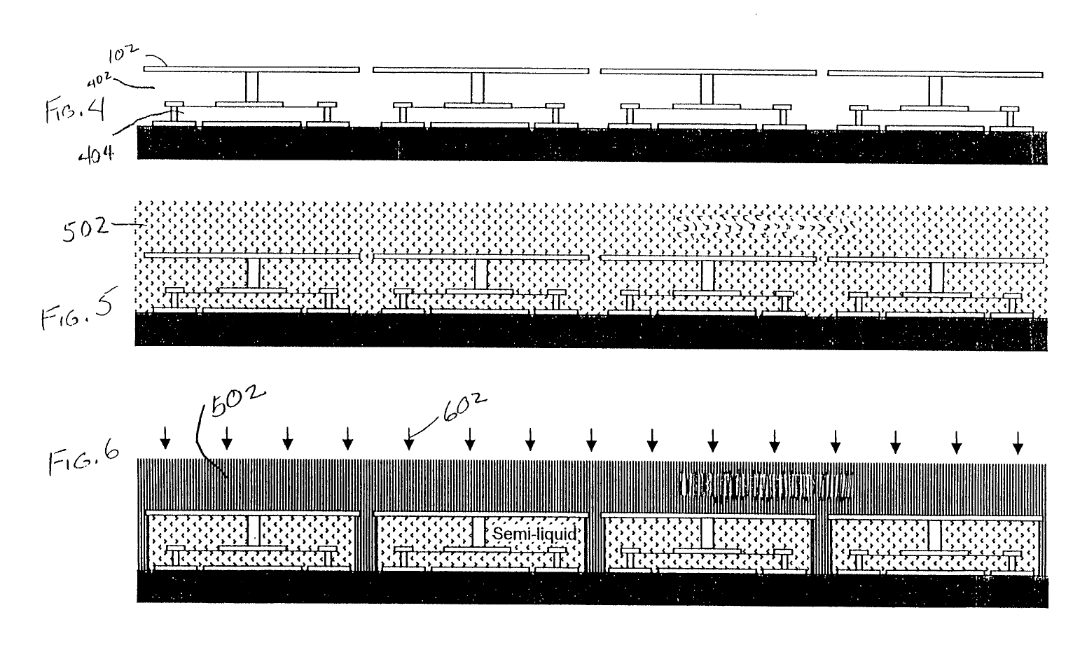

FIG. 4 is a side view of a portion of a micromirror array. In FIG. 4, the mirror 102 is supported above a void 402 formed by the removal of the second spacer layer. Likewise, the hinge 120 and hinge yolk 114 are supported above a void 404 formed by the removal of the first spacer layer. In FIG. 5, a liquid overcoat material 502 has been deposited on the micromirror array and allowed to soak in between and beneath the micromirrors. In FIG. 6, the liquid resin 502 has been solidified by the application of ultraviolet or thermal energy 602. As shown in FIG. 6, the ultraviolet energy has been unable to reach the liquid beneath the micromirrors and the resin remains in liquid from beneath the mirrors. As described above, thermal energy is used to fully cure the resin underneath the micromirrors.

The protective coating 502 need only be thick enough to protect the mechanical structures of the device. Typically, a coating on the order of 10 μm thick is sufficient to fill and protect the device. Coatings that are excessively thick typically are more difficult to remove.

Thus, although there has been disclosed to this point a particular embodiment of methods of recoating micromechanical devices, it is not intended that such specific references be considered as limitations upon the scope of this invention except insofar as set forth in the following claims. Furthermore, having described the invention in connection with certain specific embodiments thereof, it is to be understood that further modifications may now suggest themselves to those skilled in the art, it is intended to cover all such modifications as fall within the scope of the appended claims.

What is claimed is:

1. A method of fabricating a micromechanical device, the method comprising:
forming at least two micromechanical devices on a common substrate;
applying a liquid overcoat material to said micromechanical devices;
separating said common substrate to separate said devices; and
removing said overcoat from said micromechanical devices.

2. The method of claim 1, said applying a liquid overcoat material comprising:
immersing said common substrate in a liquid overcoat material;

3. The method of claim 1, said applying a liquid overcoat material comprising:
applying said liquid overcoat material to said common substrate; and
spinning said common substrate to disperse said liquid overcoat material.

4. The method of claim 1, said applying a liquid overcoat material comprising:
spraying said liquid overcoat material onto said common substrate.

5. The method of claim 1, said applying a liquid overcoat material comprising:
spraying said liquid overcoat material onto said common substrate using a low pressure spray.

6. The method of claim 1, said applying a liquid overcoat material comprising:
spraying said liquid overcoat material onto said common substrate using a high pressure spray.

7. The method of claim 1, said applying a liquid overcoat material comprising:
spraying said liquid overcoat material onto said common substrate using a low pressure pneumatic spray.

8. The method of claim 1, said applying a liquid overcoat material comprising:
spraying said liquid overcoat material onto said common substrate using a high pressure pneumatic spray.

9. The method of claim 1, said applying a liquid overcoat material comprising:
nebulizing said liquid overcoat material using Meinhard nebulization; and
spraying said nebulized liquid overcoat material onto said common substrate.

10. The method of claim 1, said applying a liquid overcoat material comprising:
nebulizing said liquid overcoat material using ultrasonic nebulization; and
spraying said nebulized liquid overcoat material onto said common substrate.

11. The method of claim 1, said applying a liquid overcoat material comprising:
dispensing droplets of said liquid overcoat material from a nozzle using a heated droplet dispenser; and
depositing said droplets onto said common substrate.

12. The method of claim 1, comprising:
curing said liquid overcoat material.

13. The method of claim 1, comprising:
curing said liquid overcoat material by heating said liquid overcoat material.

14. The method of claim 1, comprising:
curing said liquid overcoat material using ultraviolet light.

15. The method of claim 1, said applying a liquid overcoat material to said micromechanical devices comprising:
applying a urethane acrylate resin.

16. The method of claim 1, said applying a liquid overcoat material to said micromechanical devices comprising:
applying an epoxy acrylate resin.

17. The method of claim 1, said applying a liquid overcoat material to said micromechanical devices comprising:
applying an acrylate monomer.

18. The method of claim 1, said removing said overcoat from said micromechanical devices comprising:
removing said overcoat using an isotropic etch.

19. A method of fabricating a micromechanical device, the method comprising:
forming at least two micromechanical devices on a common substrate;
immersing said common substrate in a liquid overcoat material to coat said micromechanical devices;
separating said common substrate to separate said devices; and
removing said overcoat from said micromechanical devices.

20. The method of claim 19, comprising:
spinning said common substrate to disperse said liquid overcoat material.

21. The method of claim 19, comprising:
curing said liquid overcoat material.

22. The method of claim 19, said applying a liquid overcoat material to said micromechanical devices comprising:
applying a urethane acrylate resin.

23. The method of claim 19, said applying a liquid overcoat material to said micromechanical devices comprising:
applying an epoxy acrylate resin.

24. The method of claim 19, said applying a liquid overcoat material to said micromechanical devices comprising:
applying an acrylate monomer.

25. The method of claim 19, said removing said overcoat from said micromechanical devices comprising:
removing said overcoat using an isotropic etch.

26. A method of fabricating a micromechanical device, the method comprising:
forming at least two micromechanical devices on a common substrate;
spraying a liquid overcoat material onto said common substrate to coat said micromechanical devices;
separating said common substrate to separate said devices; and
removing said overcoat from said micromechanical devices.

27. The method of claim 26, comprising:
curing said liquid overcoat material.

28. The method of claim 26, said applying a liquid overcoat material to said micromechanical devices comprising:
applying a urethane acrylate resin.

29. The method of claim 26, said applying a liquid overcoat material to said micromechanical devices comprising:
applying an epoxy acrylate resin.

30. The method of claim 26, said applying a liquid overcoat material to said micromechanical devices comprising:
applying an acrylate monomer.

31. The method of claim 26, said removing said overcoat from said micromechanical devices comprising:
removing said overcoat using an isotropic etch.

32. A method of fabricating a micromechanical device, the method comprising:
forming at least two micromechanical devices on a common substrate;
nebulizing a liquid overcoat material;
spraying said nebulized liquid overcoat material onto said common substrate to coat said micromechanical devices;
separating said common substrate to separate said devices; and
removing said overcoat from said micromechanical devices.

33. The method of claim 32, said nebulizing said liquid overcoat material comprising:
nebulizing said liquid overcoat material using Meinhard nebulization.

34. The method of claim 32, said nebulizing said liquid overcoat material comprising:
nebulizing said liquid overcoat material using ultrasonic nebulization.

35. The method of claim 32, comprising:
curing said liquid overcoat material.

36. The method of claim 32, said applying a liquid overcoat material to said micromechanical devices comprising:
applying a urethane acrylate resin.

37. The method of claim 32, said applying a liquid overcoat material to said micromechanical devices comprising:
applying an epoxy acrylate resin.

38. The method of claim 32, said applying a liquid overcoat material to said micromechanical devices comprising:
applying an acrylate monomer.

39. The method of claim 32, said removing said overcoat from said micromechanical devices comprising:
removing said overcoat using an isotropic etch.

40. A method of fabricating a micromechanical device, the method comprising:
forming at least two micromechanical devices on a common substrate;
dispensing droplets of a liquid overcoat material from a nozzle using a heated droplet dispenser;
depositing said droplets onto said common substrate to coat said micromechanical devices;
separating said common substrate to separate said devices; and
removing said overcoat from said micromechanical devices.

41. The method of claim 40, comprising:
curing said liquid overcoat material.

42. The method of claim 40, said applying a liquid overcoat material to said micromechanical devices comprising:
applying a urethane acrylate resin.

43. The method of claim 40, said applying a liquid overcoat material to said micromechanical devices comprising:
applying an epoxy acrylate resin.

44. The method of claim 40, said applying a liquid overcoat material to said micromechanical devices comprising:
applying an acrylate monomer.

45. The method of claim 40, said removing said overcoat from said micromechanical devices comprising:
removing said overcoat using an isotropic etch.
